(19) United States
(12) Patent Application Publication
(10) Pub. No.: US 2007/0092069 A1
(43) Pub. Date: Apr. 26, 2007

(54) Method and system for testing enterprise applications

(75) Inventors: Semyon Royzen, San Francisco, CA (US); Thomas Hempel, Redwood City, CA (US)

Correspondence Address: Semyon Royzen, 147 Dorado Terrace, San Francisco, CA, 94112, US

(73) Assignee: Epiphany, Inc.

(21) Appl. No.: 11/255,363

(22) Filed: Oct. 21, 2005

(51) Int. Cl. H04M 1/24

(52) U.S. Cl. 379/27.04

(57) ABSTRACT

A method for testing an enterprise application program is provided. In this method, metadata is received from the enterprise application program and a test script is generated based on the metadata. The test script then is translated to a user interface action. A system and computer readable medium for testing the enterprise application program also are described.

### FIELD OF THE INVENTION

The present invention relates to enterprise applications and, more particularly, to methods and systems for testing enterprise applications.

### BACKGROUND

The automated testing of an enterprise application program usually requires the generation of commands to the enterprise application program and the validation of outputs as a result of the commands. In a typical automated test approach, users manually hardcode test scripts to generate user interface actions that directly map to user interfaces of the enterprise application program. However, if the user interfaces of the enterprise application program change, the test scripts must also be updated because the user interface actions directly map to the user interfaces. The manual updates to the test scripts are labor-intensive and can result in unstable test scripts because of the complicated updates.

Another test approach is model-based test automation where a formal model is created that describes the behavior of a system under test. After the creation of the formal model, the actual behavior of the system under test is compared with a simulation that is based on the formal model. The formal model can be either hardcoded or derived from an external specification, such as one represented in Unified Modeling Language (UML). A common limitation of the model-based test automation approach is that the formal model is difficult to create because such an approach can only derive limited information from the enterprise application program. For example, the model-based test automation approach cannot derive metadata associated with user interfaces, thereby preventing automatic execution against the user interfaces. Furthermore, the UML model lacks synchronization with the typical metadata used by the enterprise application program.

As a result, there is a need to provide methods and systems for testing an enterprise application program that is not labor intensive and can easily adapt to updates of the enterprise application program.

### SUMMARY

Broadly speaking, the present invention fills these needs by providing methods and systems for testing an enterprise application program. It should be appreciated that the present invention can be implemented in numerous ways, including as a method, a system, or a device. Several inventive aspects of the present invention are described below.

In accordance with a first aspect of the present invention, a method for testing an enterprise application program is provided. In this method, business model metadata and controller metadata are received from the enterprise application program and a test script is generated based on the business model metadata and the controller metadata. The test script is then translated to a user interface action.

In accordance with a second aspect of the present invention, a computer readable medium having program instructions for testing an enterprise application program is provided. The computer readable medium includes program instructions for exporting business model metadata and controller metadata from the enterprise application program to an Extensible Markup Language (XML) schema file. Additionally included are program instructions for generating a test script based on the XML schema file and program instructions for translating the test script to a user interface action.

In accordance with a third aspect of the present invention, a system for testing an enterprise application program is provided. The system includes a server computing device that includes memory for storing an enterprise application testing module and a processing unit for executing the enterprise application testing module. The enterprise application testing module includes program instructions for importing metadata from the enterprise application program, program instructions for generating a test script based on the metadata, and program instructions for translating the test script to a user interface action.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1 is a simplified block diagram of an exemplary system for testing an enterprise application program.

FIG. 2 is a flowchart diagram of a high level overview of an exemplary method for generating user interface actions for use in testing an enterprise application program.

FIG. 3 is a simplified block diagram of exemplary metadata from an enterprise application program.

FIG. 4 is a flowchart diagram of an exemplary method for generating user interface actions using the exemplary metadata shown in FIG. 3.

FIG. 5 is a diagram illustrating an exemplary testing of an enterprise application program.

### DETAILED DESCRIPTION

The invention may be implemented in numerous ways, including as a system, a process, an apparatus, or as computer program instructions included on a computer readable medium such as a computer readable storage medium or a computer network wherein program instructions are sent over optical or electronic communication links.

A detailed description of one or more examples is provided below along with accompanying figures. The detailed description is provided in connection with such examples, but is not limited to any particular embodiment. The scope is limited only by the claims and numerous alternatives, modifications, and equivalents are encompassed. Numerous specific details are set forth in the following description in order to provide a thorough understanding. These details are provided for the purpose of example and the described embodiments may be implemented according to the claims without some or all of these specific details. For the purpose of clarity, technical material that is known in the technical fields related to the embodiments has not been described in detail to avoid unnecessarily obscuring the description.

The embodiments described herein provide methods and systems for testing enterprise applications. Essentially, as will be explained in more detail below, real-world metadata used by an enterprise application program is reused for capturing information about the enterprise application program that is used for testing. For example, in one embodiment, metadata from the enterprise application program is imported and test scripts are generated based on the imported metadata. The test scripts are then translated to user interface actions, which are used during testing to provide user commands to the enterprise application program.

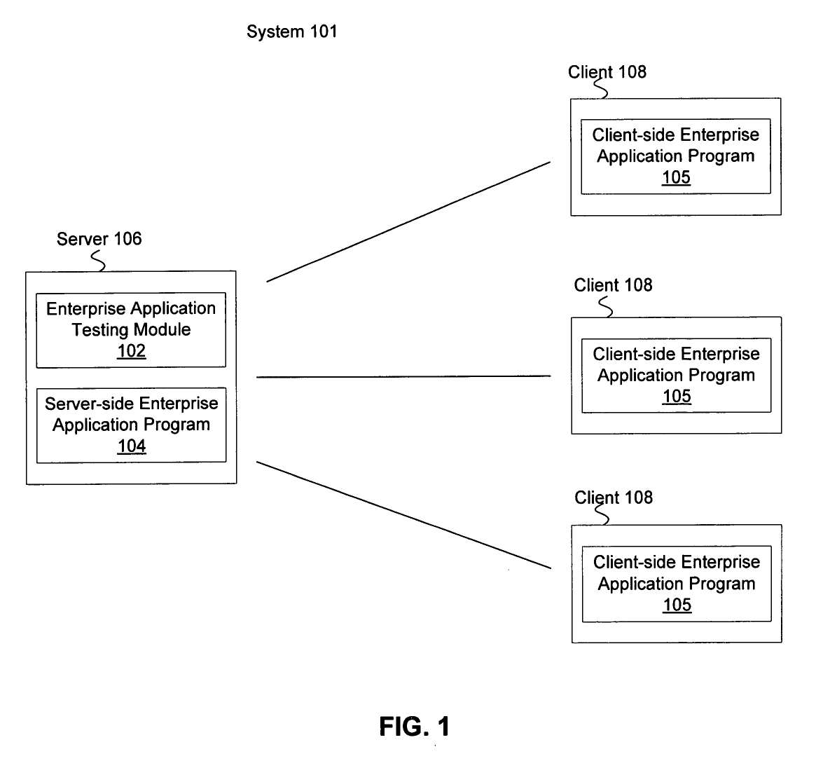

FIG. 1 is a simplified block diagram of an exemplary system for testing an enterprise application program. System 101 includes server 106 in communication with clients 108. It should be appreciated that server 106 and clients 108 may include any suitable type of computing device. For example, the computing device can include a computer system based on a processing unit (e.g., a microprocessor) and memory (e.g., random access memory, hard disk, optical media, etc.), a portable computing device, a personal digital assistant, and a computational engine within an appliance.

Enterprise application program, such as server-side enterprise application program 104 and client-side enterprise application programs 105, can be hosted on server 106 and additionally executed on clients 108. Enterprise application program can include any suitable application software that provides business logic support functionality. Exemplary enterprise application program includes customer relationship management software, financial management software, project management software, etc. As shown in FIG. 1, server-side enterprise application program 104 may be hosted on server 106 that simultaneously provides services to multiple clients 108. Server-side enterprise application program 104 runs on server 106 that may include one or more computers dedicated for hosting the sever-side enterprise application program. Client-side enterprise application programs 105 run on clients 108 and can rely on server 106 for information and computational-intensive application tasks. Clients 108 and server 106 may be in communication through any suitable communication channel. For example, clients 108 and server 106 may in communication through a computer network which includes any suitable type of wire or wireless communication channel capable of linking together computing nodes.

In addition to hosting server-side enterprise application program 104, server 106 can also host enterprise application testing module 102. As will be explained in more detail below, in one embodiment, enterprise application testing module 102 includes logic and/or program instructions for generating test scripts based on metadata received from enterprise application programs 104, 105 and for translating the test scripts to user interface actions.

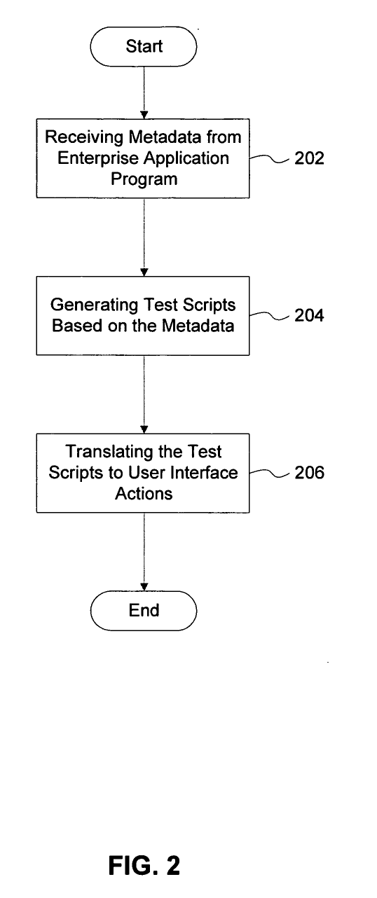

FIG. 2 is a flowchart diagram of a high level overview of an exemplary method for generating user interface actions for use in testing an enterprise application program. Starting in operation 202, metadata from the enterprise application program is received. The metadata may be real-world metadata used by the enterprise application program. In other words, the metadata may be live metadata currently being used by the enterprise application program. Thereafter, in operation 204, test scripts are generated based on the metadata and, in operation 206, the test scripts are translated to user interface actions. The user interface actions may then be used during testing to provide user commands to the enterprise application program. As a result of the user commands, the enterprise application program generates outputs that can then be validated by the enterprise application testing module.

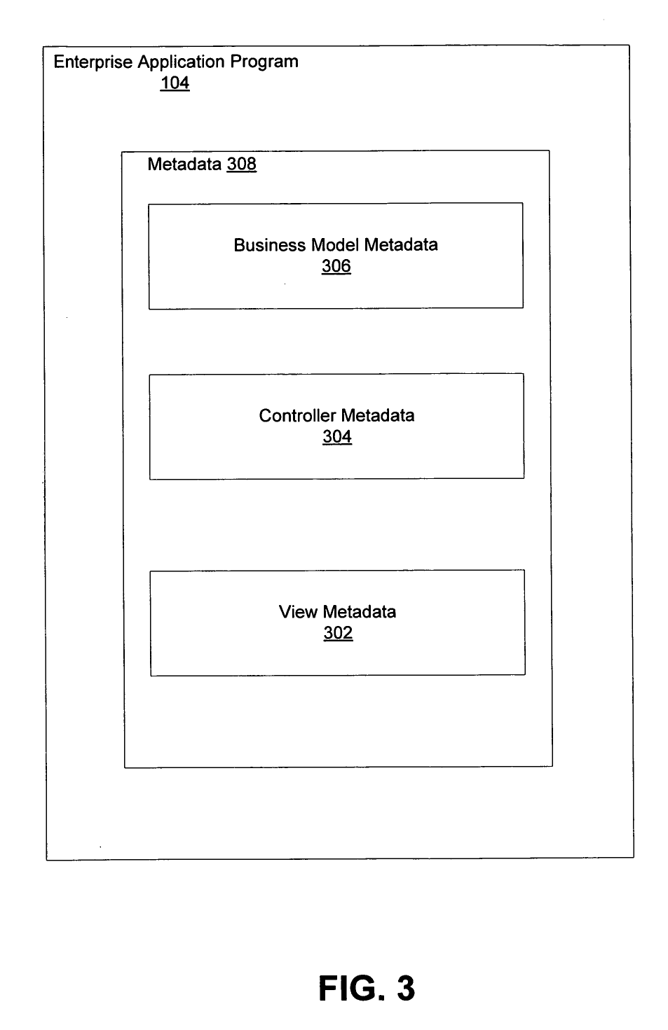

FIG. 3 is a simplified block diagram of exemplary metadata from an enterprise application program. It should be appreciated that in general, metadata is information that describes another set of data. Metadata may include descriptive information about the quality, context, condition, and/or characteristics of another set of data. For example, in a model-based enterprise application program 104, metadata 308 used by the enterprise application program may include three, distinct parts. As shown in FIG. 3, the three parts include business model metadata 306, controller metadata 304, and view metadata 302. Business model metadata 306 describes business objects and actions. Controller metadata 304 describes controller actions and mappings of the controller actions to the business actions. View metadata 302 describes user interface elements, events, and mappings of the elements and events to business model metadata 306 and controller metadata 304.

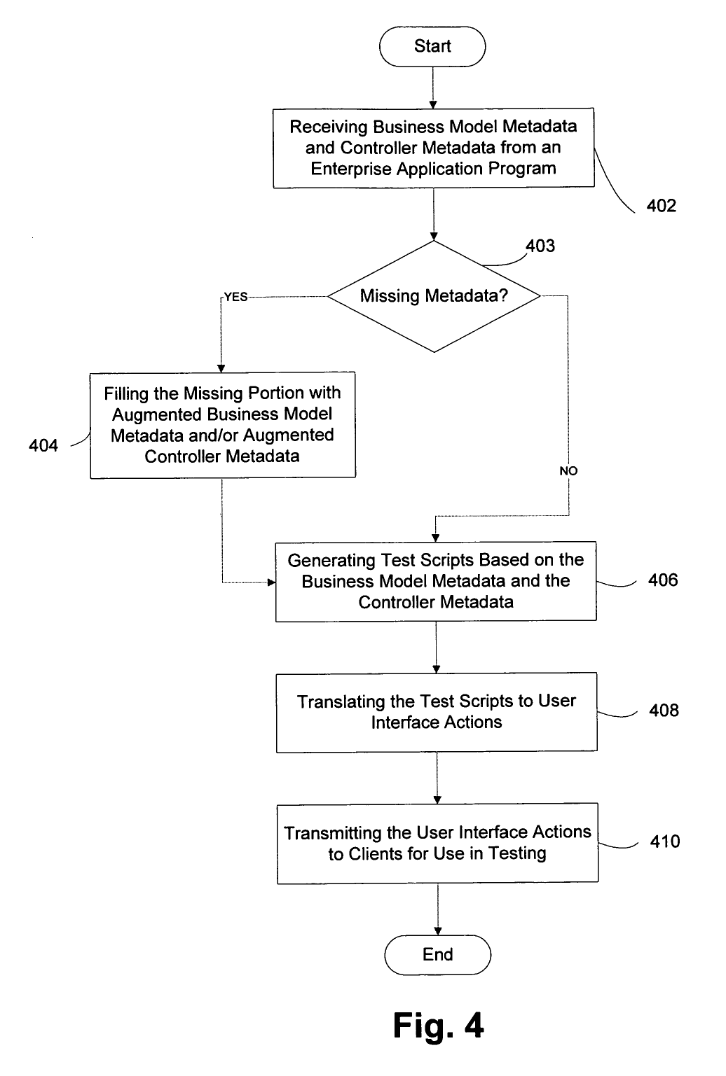

FIG. 4 is a flowchart diagram of an exemplary method for generating user interface actions using the exemplary metadata shown in FIG. 3. As discussed above, in a model-based enterprise application program, the metadata used in the enterprise application program may include business model metadata, controller metadata, and view metadata. As shown in FIG. 4, to generate user interface actions, operation 402 shows that business model metadata and controller metadata are initially received from the enterprise application program. In one embodiment, the business model metadata and controller metadata may be received by direct importation from the enterprise application program. In another embodiment, as will be explained in more detail below, the business model metadata and the controller metadata may be received by exporting the business model metadata and the controller metadata to a suitable file. For instance, the business model metadata and the controller metadata can be exported as an Extensible Markup Language (XML) schema file, which includes the interrelationship between attributes and elements of XML objects. Other exemplary exportable files include Regular Language for XML Next Generation (RELAX NG), Document Definition Markup Language (DDML), Document Structure Description (DSD), Document Type Definition (DTD), etc.

Thereafter, in one embodiment, a determination is made in operation 403 whether portions of the received business model metadata and/or the controller metadata are missing. It should be appreciated that portions of received metadata, such as business model metadata and controller metadata, may be missing because such metadata can be hardcoded into the program code, which cannot be easily extracted. If portions of metadata are missing, then the missing portions are filled with augmented business model metadata and/or augmented controller metadata in operation 404. In one embodiment, a user can manually fill in the missing portions with augmented metadata generated on an editor, such as an XML editor.

After the missing portions of metadata are filled in operation 404 or if the business model metadata and the controller metadata received are complete, then, as shown in operation 406, test scripts are generated based on the business model metadata and the controller metadata. As will be explained in more detail below, in one embodiment, the test scripts can be manually generated by using an editor, such as an XML editor. In another embodiment, the test scripts are automatically generated.

Still referring to FIG. 4, in operation 408, the test scripts then are translated to user interface actions. As will be explained in more detail below, in one embodiment, the translation is done by executing the test scripts with view metadata of the enterprise application program, whereby the view metadata is dynamically accessed from the enterprise application program. Thereafter, the user interface actions are transmitted to clients in operation 410 for use in testing the enterprise application program. As discussed above, the user interface actions provide user commands to the enterprise application program and, as a result, generate outputs which can then be validated during testing.

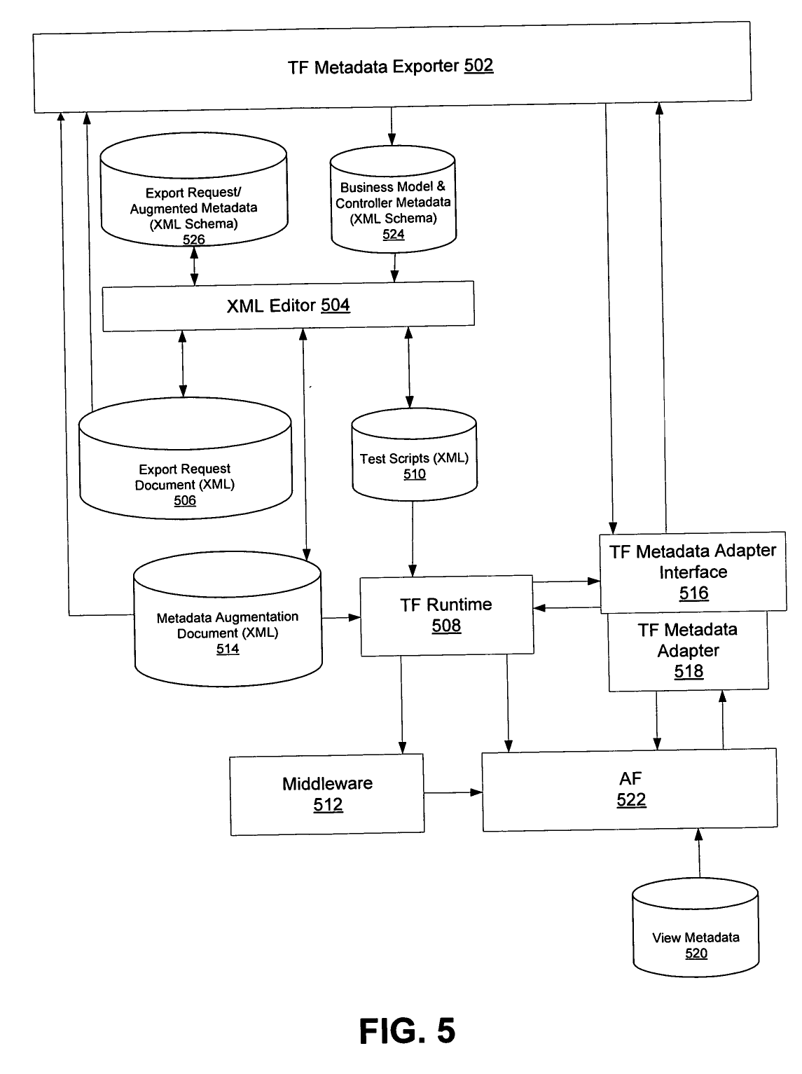

FIG. 5 is a diagram illustrating an exemplary testing of an enterprise application program. Instead of testing the complete application framework 522 (i.e., enterprise application program), it should be appreciated that a portion of the application framework can be tested. In particular, each business module (e.g., customer module, product module, etc.) of application framework 522 can be individually tested. Accordingly, in one embodiment, the portions of the business model metadata and the controller metadata exported depend on the business modules being exported. As shown in FIG. 5, with the use of XML editor 504 (e.g., XML SPY), a user may create or update export request document 506, which is a list of business modules to export based on predefined export request 526. Export request document 506 may be created when a new application framework, such as application framework 522, is being tested or may be updated when business modules change. Export request document 506 may be in XML format and export request 526 may be an XML schema file.

Additionally, as discussed above, if portions of metadata are missing, then the missing portions can be filled with augmented metadata. As shown in FIG. 5, if portions of metadata are missing, then a user can create or update metadata augmentation document 514 with the use of XML editor 504 based on export request and augmented metadata 526. In one embodiment, metadata augmentation document 514 can be created based on a predefined XML schema. The user may use metadata augmentation document 514 to add any desired metadata, of any of the supported kinds of metadata. When test framework metadata exporter 502 runs, the test framework metadata exporter merges the metadata from application framework 522 with any data obtained from metadata augmentation document 514. Since augmented metadata 526 is built before the export, the augmented metadata is used for compensating any deficiencies or missing information in application framework 522. The user may modify metadata augmentation document 514 and reexport the metadata of application framework 522 until the desired results are obtained. It should be appreciated that metadata augmentation document 514 can be in XML format and export request and augmented metadata 526 can be an XML schema file.

After export request document 506, metadata augmentation document 514, business model metadata, and/or controller metadata have been updated or created, test framework metadata exporter 502 exports business model metadata and controller metadata as XML schema files 524. It should be noted that an enterprise application testing module can be referred to as a test framework. Thereafter, with the use of XML editor 504, a user may generate test scripts 510 in XML format based on XML schema files 524 of the business model metadata and controller metadata. In one embodiment, there may be two forms of test scripts 510. One form includes test scripts for automatic generation of a whole collection of tests. Another form includes manually generated test scripts for individual tests. In both forms, test scripts 510 may be XML documents governed by the XML schemas. A test framework has the ability to automatically create tests that try all combination of objects and actions. Since for any case, such ability can produce a near infinite sequence, constraints may be introduced in the generation process to create a useful, finite series of tests.

Test framework runtime 508 then executes test scripts 510 using dynamically accessed view metadata 520 of application framework 522 to translate the test scripts to user interface actions. In one exemplary embodiment, a mapping provided by view metadata 520 may be used to translate specific actions of test scripts 510 into user interface actions. It should be appreciated that middleware 512 acts as an intermediary between test framework and application framework 522. Test framework metadata adapter 518 and test framework metadata adapter interface 516 include components for the test framework to interface with application framework 522.

In summary, the above-described embodiments provide methods and systems for testing enterprise applications. As discussed above, the metadata of an enterprise application program can be reused for capturing information about the enterprise application program. The reuse of metadata eliminates the need for a user to manually construct a model and to manually hardcode test scripts for testing an enterprise application program every time the enterprise application is updated. Furthermore, the practical complexity of testing enterprise applications is reduced with the allowance of portions of the enterprise application program to be tested and the allowance of some manual intervention (e.g., the augmentation of missing metadata).

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

The invention can also be embodied as computer readable code on a computer readable medium. The computer readable medium is any data storage device that can store data which can be thereafter read by a computer system. The computer readable medium also includes an electromagnetic carrier wave in which the computer code is embodied. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion.

Any of the operations described herein that form part of the invention are useful machine operations. The invention also relates to a device or an apparatus for performing these operations. The apparatus may be specially constructed for the required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The above described invention may be practiced with other computer system configurations including hand-held devices, microprocessor systems, microprocessor-based or programmable consumer electronics, minicomputers, mainframe computers and the like. Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims.

What is claimed is:

1. A method for testing an enterprise application program, comprising method operations of:
receiving business model metadata and controller metadata from the enterprise application program;
generating a test script based on the business model metadata and the controller metadata; and
translating the test script to a user interface action.

2. The method of claim 1, further comprising:
transmitting the user interface action to a client computing device, the user interface action being configured to provide a user command to the enterprise application program to enable the testing of the enterprise application program.

3. The method of claim 1, wherein the business model metadata and the controller metadata are real-world metadata configured for use by the enterprise application program.

4. The method of claim 1, wherein the method operation of translating the test script to the user interface action includes,
executing the test script with view metadata of the enterprise application program, the view metadata being dynamically accessed from the enterprise application program.

5. The method of claim 1, further comprising:
if a portion of the business model metadata is missing, filling the portion with augmented business model metadata.

6. The method of claim 1, further comprising:
if a portion of the controller metadata is missing, filling the portion with augmented controller metadata.

7. The method of claim 1, wherein the business model metadata and the controller metadata are received as an Extensible Markup Language (XML) schema file from the enterprise application program.

8. The method of claim 1, wherein the test script is generated using an Extensible Markup Language (XML) editor.

9. The method of claim 1, wherein the test script is automatically generated.

10. A computer readable medium having program instructions for testing an enterprise application program, comprising computer instructions for:
program instructions for exporting business model metadata and controller metadata from the enterprise application program to an Extensible Markup Language (XML) schema file;
program instructions for generating a test script based on the XML schema file; and
program instructions for translating the test script to a user interface action.

11. The computer readable medium of claim 10, wherein a portion of the business model metadata and the controller metadata exported depends on business modules of the enterprise application program being exported.

12. The computer readable medium of claim 10, wherein the program instructions for translating the test script to the user interface action includes,
program instructions for executing the test script with view metadata of the enterprise application program, the view metadata being dynamically accessed from the enterprise application program.

13. A system for testing an enterprise application program, comprising:
a server computing device that includes,
a memory for storing an enterprise application testing module, and
a processing unit for executing the enterprise application testing module stored in the memory, the enterprise application testing module including,
program instructions for importing metadata from the enterprise application program,
program instructions for generating a test script based on the metadata, and
program instructions for translating the test script to a user interface action.

14. The system of claim 13, wherein the metadata includes business model metadata and controller metadata.

15. The system of claim 13, further comprising:
a client computing device in communication with the server computing device,
wherein the enterprise application testing module further includes program instructions to transmit the user interface action to the client computing device, the user interface action being configured to provide a user command to the enterprise application program.

16. The system of claim 13, wherein the program instructions for translating the test script to the user interface action includes,
program instructions for executing the test script with view metadata of the enterprise application program, the view metadata being dynamically accessed from the enterprise application program.

17. The system of claim 13, wherein the metadata is real-world metadata configured for use by the enterprise application program.
